(19) United States
(12) Patent Application Publication
(10) Pub. No.: US 2025/0050258 A1
(43) Pub. Date: Feb. 13, 2025

(54) TOROIDAL BLADE INERTIAL SEPARATOR

(71) Applicant: Donaldson Company, Inc., Bloomington, MN (US)

(72) Inventors: Gerald E. Weineck, II, St. Paul, MN (US); Daryl L. Quam, Bloomington, MN (US)

(21) Appl. No.: 18/799,285

(22) Filed: Aug. 9, 2024

Related U.S. Application Data
(60) Provisional application No. 63/518,506, filed on Aug. 9, 2023.

(51) Int. Cl. B01D 45/16; B01D 46/24; B01D 50/20

(52) U.S. Cl. CPC B01D 45/16; B01D 46/2411; B01D 50/20

(57) ABSTRACT

A separator arrangement including a tubular member extending along a longitudinal axis and a toroidal blade arrangement disposed within the tubular member in a fixed position. The toroidal blade arrangement can include a plurality of blade members, each being looped from a first end to a second end with a radially distal portion located between the first and second ends to define a radially bounded passageway extending along a second axis disposed at an oblique angle to the longitudinal axis. In one aspect, each of the blade members is looped such that an inner side surface presents both a leading face and a trailing face.

### RELATED APPLICATION

This application claims priority to U.S. Provisional Application Ser. No. 63/518,506, filed on Aug. 9, 2023, the entirety of which is incorporated by reference herein.

### TECHNICAL FIELD

The present invention relates to filter arrangements, typically for use in filtering air, such as intake air for internal combustion engines, and more particularly relates to filter assemblies that include multiple components arranged in a housing to provide desired filtering capabilities.

### BACKGROUND

Air or other gas filtering is desirable in a number of systems. A typical application is in the filtration of intake air to internal combustion engines. Another is in the filtration of crankcase ventilation filter assemblies. Typically, such systems comprise filter assemblies having a serviceable filter cartridge therein. After a period of use, filter media within a filter housing requires servicing, either through cleaning or complete replacement. Typically, for an air cleaner or crankcase ventilation filter assembly used with an internal combustion engine, for example, on a vehicle, the filter media is contained in a removable and replaceable, i.e. serviceable, component, typically referred as a filter element or cartridge. In some applications, particularly where a machine operates in a harsh environment, a precleaner assembly can be utilized to remove relatively large contaminants from the airflow stream in order to extend the life of the filter media.

### SUMMARY

An air cleaner assembly for filtering intake air for a power plant can include a filter cartridge disposed within a housing of the air cleaner assembly, a precleaner assembly including at least separator arrangement for separating particulates from an airflow stream

In an example, a separator arrangement can include a tubular member extending along a longitudinal axis between an inlet end and an outlet end; and a separation tube extending at least partially into the outlet end of the tubular member such that an annulus is formed between the separation tube and the tubular member; and a toroidal blade arrangement disposed within the tubular member between the inlet end and the separation tube, the toroidal blade arrangement including a plurality of blade members defining an inlet side and an outlet side. Each of the plurality of blade members can extend from first end to a second end and between an inner side surface and an opposite outer side surface; and can be looped such that a first portion of the inner side surface defines a leading face at least partially facing the inlet side and such that a second portion of the inner side surface defines a trailing face at least partially facing the outlet side.

One or both of the first and second ends of each of the plurality of blade members may extend to an adjacent one of the plurality of blade members.

Each of the plurality of blade members may extend between a leading edge and a trailing edge, wherein one or both of the leading and trailing edges extend along a plane that is generally orthogonal to the longitudinal axis.

The leading edges can generally extend along a first plane and the trailing edges generally extend along a second plane that is parallel to the first plane.

The inner side surface of each of the plurality of blade members can define a radially bounded passageway extending along a second axis disposed at an oblique angle to the longitudinal axis.

The inner side surface can define an extruded surface.

The blade arrangement can include a central portion to which at least a portion of each of the plurality of blade members extends.

The plurality of blade members can include at least four blade members.

The plurality of blade members can include at least eight blade members.

In some examples, none of the plurality of blade members contacts another of the plurality of blade members.

In some examples, at least one of the plurality of blade members has a size or shape that is different from at least one other of the plurality of blade members.

In one aspect, a separator arrangement is provided that can include a tubular member extending along a longitudinal axis and a toroidal blade arrangement disposed within the tubular member in a fixed position. The toroidal blade arrangement can include a plurality of blade members, each of which extending from a first end to a second end with a radially distal portion located between the first and second ends to define a radially bounded passageway extending along a second axis disposed at an oblique angle to the longitudinal axis.

One or both of the first and second ends of each of the plurality of blade members may extend to an adjacent one of the plurality of blade members.

Each of the plurality of blade members can extend between a leading edge and a trailing edge, and wherein one or both of the leading and trailing edges extend along a plane that is generally orthogonal to the longitudinal axis.

The leading edges can generally extend along a first plane and the trailing edges can generally extend along a second plane that is parallel to the first plane.

The radially bounded passageway of each of the plurality of blade members can at least partially be defined by an inner side surface of the blade member, wherein the inner side surface is parallel to the second axis.

The inner side surface can define an extruded surface.

The blade arrangement can include a central portion to which at least a portion of each of the plurality of blade members extends.

The plurality of blade members can include at least four blade members.

The plurality of blade members can include at least eight blade members.

In some examples, none of the plurality of blade members contacts another of the plurality of blade members.

A pre-cleaner for an air cleaner assembly can include a housing extending along a longitudinal axis and between an inlet end for receiving an unseparated airflow stream and an outlet end for delivering a separated airflow stream, the housing including an ejection port for discharging contaminants removed from the unseparated airflow stream; and a separator arrangement disposed within the housing and configured to separate the contaminants from the unseparated airflow stream, the separator arrangement including at least one toroidal blade arrangement mounted in a fixed, non-rotatable position.

In some examples, the separator arrangement includes a plurality of toroidal blade arrangements.

In some examples, the toroidal blade arrangement includes a plurality of blade members, each of which extends from a first end to a second end with a radially distal portion located between the first and second ends to define a radially bounded passageway extending along a second axis disposed at an oblique angle to the longitudinal axis.

In some examples, the separator arrangement includes an inlet flow tube and an outlet flow tube extending at least partially into the inlet flow tube to define an annulus between the inlet and outlet flow tubes, and wherein the toroidal blade arrangement is disposed within the inlet flow tube at a location upstream of the outlet flow tube.

An air cleaner assembly can include an air cleaner housing; a filter cartridge mounted within the air cleaner housing; and any of the above-described pre-cleaners and/or separator arrangements.

A variety of additional aspects will be set forth in the description that follows. The aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

The present invention will be further explained with reference to the appended Figures, wherein like structure is referred to by like numerals throughout the several views.

FIG. 1 is a schematic of a system including an air cleaner assembly having features in accordance with the present disclosure.

FIG. 2 is a schematic perspective view of an example air cleaner assembly provided with a precleaner assembly usable with the system shown in FIG. 1.

FIG. 3 is a schematic cross-sectional view of the air cleaner assembly shown in FIG. 2.

FIG. 4 is a schematic end view of a separator arrangement of the precleaner shown in FIGS. 2 and 3.

FIG. 5 is a schematic cross-sectional side view of the separator arrangement shown in FIG. 4.

FIG. 6 is a schematic first perspective view of a toroidal blade arrangement of the separator arrangement shown in FIG. 4.

FIG. 7 is a schematic second perspective view of a toroidal blade arrangement of the separator arrangement shown in FIG. 4.

FIG. 8 is a schematic first end view of a toroidal blade arrangement of the separator arrangement shown in FIG. 4.

FIG. 9 is a schematic second end view of a toroidal blade arrangement of the separator arrangement shown in FIG. 4.

FIG. 10 is a schematic side view of a toroidal blade arrangement of the separator arrangement shown in FIG. 4.

FIG. 11 is a schematic partial perspective cross-sectional view of a toroidal blade arrangement of the separator arrangement shown in FIG. 4.

FIG. 12 is a schematic end view of a second embodiment of a separator arrangement usable with the precleaner shown in FIGS. 2 and 3.

FIG. 13 is a schematic end view of a third embodiment of a separator arrangement usable with the precleaner shown in FIGS. 2 and 3.

FIG. 14 is a schematic end view of a fourth embodiment of a separator arrangement usable with the precleaner shown in FIGS. 2 and 3.

### DETAILED DESCRIPTION

Herein, example filter assemblies, filter cartridges, features and components therefor are described and depicted. A variety of specific features and components are characterized in detail. Many can be applied to provide advantage. There is no specific requirement that the various individual features and components be applied in an overall assembly with all of the features and characteristics described, however, in order to provide for some benefit in accord with the present disclosure.

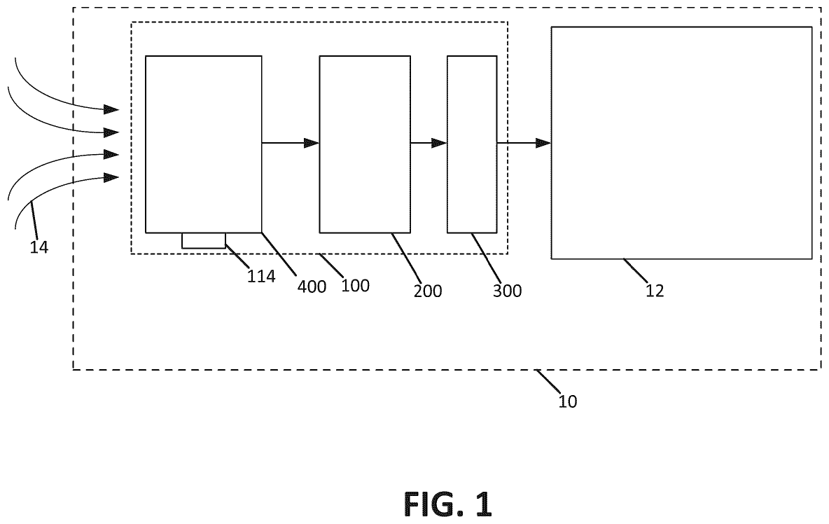

Referring to FIG. 1, a system including an air cleaner assembly 100 is schematically presented. As depicted, the air cleaner assembly 100 includes a precleaner 400 and filter cartridges 200, 300 which sequentially remove particulates from an airflow 14 such that clean air can be delivered to an air-consuming device 12, such as an internal combustion engine of a vehicle 10, or a compressor. The precleaner 400 operates to separate and remove particulates from the air entering the cleaner assembly 100 prior to reaching filter cartridges 200, 300.

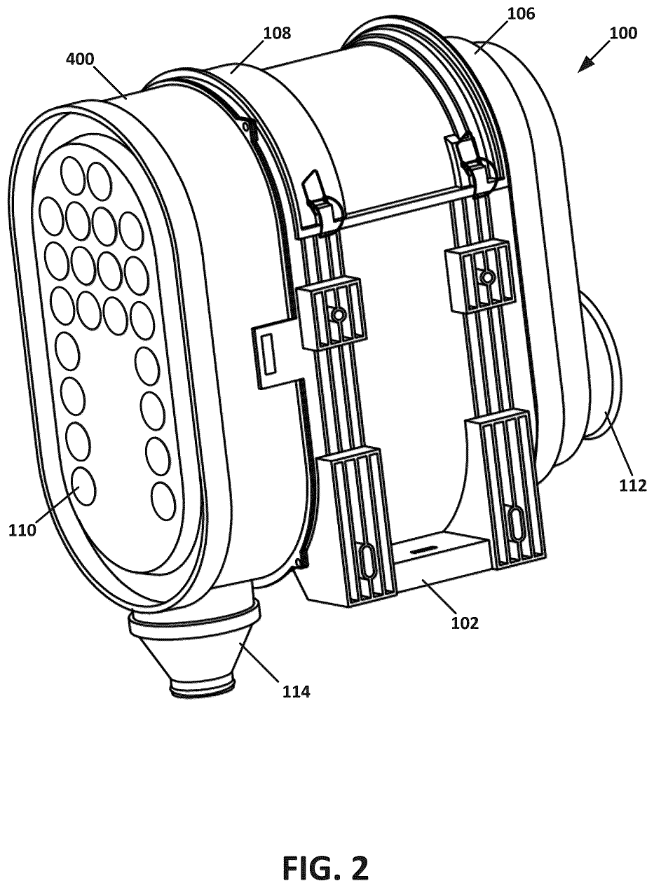

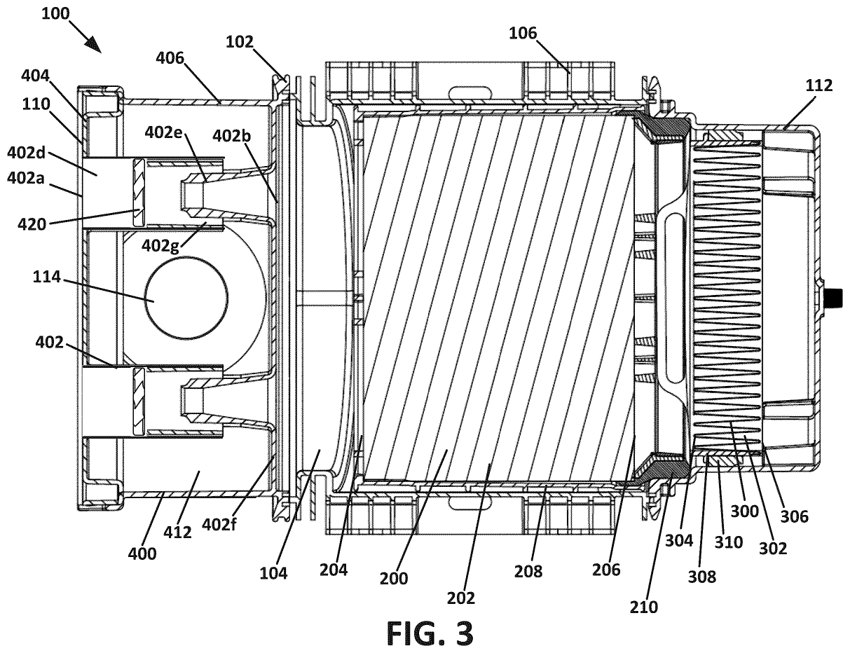

Referring to FIGS. 2 and 3, an example air cleaner assembly 100 usable in the system shown in FIG. 1 is presented. In one aspect, the air cleaner assembly 100 includes a housing 102 defining an interior cavity 104. The housing 102 can be configured as a main housing 106 and a cover 108 that allow for the interior cavity 104 to be accessed when the cover 108 is removed from the housing 106. The cover 108 can be secured to the housing 108 using any number of methods or approaches known in the art, for example by over-center latches, interacting lugs, and the like. In one aspect, the housing 102 includes an inlet 110 for accepting raw, untreated air and an outlet 112 for discharging clean, filtered air.

Referring to FIG. 3, a first filter cartridge 200, a second filter cartridge 300, and a precleaner assembly 400 are shown within the internal cavity 104 of the housing 102. These components collectively convert the unfiltered air received at the inlet 110 to the clean, filtered air delivered to the outlet 112.

In one aspect, the first filter cartridge 200 is generally positionable between the precleaner assembly 400 and the second filter cartridge 300. In a typical arrangement, the first filter cartridge 200 is removably positioned within the air cleaner assembly interior cavity 104, and would typically be considered to be a service component that is removable and replaceable, as desired and/or necessary. In one aspect, the first filter cartridge 200 includes a media pack 202 having an inlet flow face 204 for receiving pre-cleaned air from the precleaner assembly 400 and an outlet flow face 206 for delivering filtered air. In the example shown, the media pack 202 has an obround or racetrack cross-sectional shape. However, other shapes are possible, such as round, oval, and rectangular cross-sectional shapes. In one aspect, the media pack 202 defines an outer perimeter 208 extending between the inlet and outlet flow faces 204, 206. In the example shown, the media pack 202 is formed from a coiled media construction, for example a media construction having a fluted (typically corrugated) media sheet and a facing media sheet that together define parallel flutes to form a fluted or z-filter media construction. Suitable media constructions for the media pack 202 are discussed in more detail in the Media Types and Configurations section. In one aspect, the filter cartridge 200 includes a seal member 210 which forms a seal against an interior surface of the housing 102 such that all air passing through the interior cavity must pass through the media pack 202.

In one aspect, the second filter cartridge 300 is generally positionable between the outlet 112 and the first filter cartridge 200. In a typical arrangement, the second filter cartridge 300 is removably positioned within the air cleaner assembly interior cavity 104, and would typically be considered to be a service component that is removable and replaceable, as desired and/or necessary. In one aspect, the second filter cartridge 300 includes a media pack 302 having an inlet flow face 304 for receiving air from the first filter cartridge 200 and an outlet flow face 306 for delivering filtered air to the outlet 112. In the example shown, the media pack 302 has an obround or racetrack cross-sectional shape. However, other shapes are possible, such as round, oval, and rectangular cross-sectional shapes. In one aspect, the media pack 302 defines an outer perimeter 308 extending between the inlet and outlet flow faces 304, 306. In the example shown, the media pack 302 is formed from pleated media. Suitable media constructions for the media pack 302 are discussed in more detail in the Media Types and Configurations section. In one aspect, the filter cartridge 300 includes a seal member 310 which forms a seal against an interior surface of the housing 302 such that all air passing through the interior cavity must pass through the media pack 302.

Referring to FIGS. 2 and 3, the precleaner assembly 400 is shown as being a two-stage air cleaner assembly, and includes a plurality of separator tube arrangements 402. The precleaner assembly 400 is usable to preclean selected material (contaminant) carried by an air stream into the air cleaner assembly 100, before the air reaches the first filter cartridge 200 positioned therein. Such precleaning generally leads to substantial removal of liquid particulate such as rainwater or splashed water, etc. and/or various (especially larger) dust or other particles. In the example shown, contaminants removed by the precleaner assembly 400 can be discharged from the interior cavity 104 though an ejection port 114 extending through the housing 102. In some examples, the precleaner assembly 400 comprises a portion of the access cover 108.

In the example shown, the precleaner assembly 400 comprises two shell or cover components secured to one another: an outer (inlet) cover portion 404 and an inner (outlet tube) cover portion 406. In some applications characterized herein, the components 404, 406 are snap-fit or otherwise secured together, but configured to be separable to facilitate cleaning. However, in some applications of the techniques characterized herein, the two covers or shell components 404, 406 can be secured together during assembly, and not be separable again.

As stated previously, the precleaner assembly 400 can be provided with a plurality of separator tube arrangements 402. As most easily seen at FIG. 3, each of the separator tube arrangements 402 can be provided with an inlet end 402a and an outlet end 402b. Proximate the inlet end 402a, each of the separator tube arrangements 402 is provided with a toroidal blade arrangement 450 located within an inlet flow tube 402d that extends in a direction towards the outlet end 402b. In one aspect, the toroidal blade arrangement 450 is disposed in a fixed position within the inlet flow tube 402d. By use of the term ‘fixed position’ it is meant that the toroidal arrangement 104 is not capable of relative movement with respect to the inlet flow tube 402d. As presented, the toroidal blade arrangements 450 and inlet flow tubes 402d are integrally formed within the outer cover 404. However, these components may be alternatively provided separately and later attached to the outer cover 404, such as by press-fitting. In the example presented, the inlet inner cover 406 includes a plurality of outlet flow tubes 402e projecting from a tube sheet 402f. Each of the outlet flow tubes 402e projects towards the inlet end 402a and partially receives an inlet flow tube 402d, wherein an annulus or gap 402g exists between the inlet and outlet flow tubes 402e.

The general operation of the precleaner assembly 400, again, is to separate material (contaminant) upon entering into the air cleaner assembly 100 to allow for evacuation through outlet port 114 in the housing 102. This inhibits certain materials from ever reaching the internally received filter cartridge componentry (e.g. filter cartridges 100, 200). In general, each tube arrangement 402 operates with a centrifugal separation of contaminant conducted internally. To accomplish this, the air entering the inlet ends 402a, as generally directed into a cyclonic pattern by the blades of the toroidal blade arrangement 450. Due to this action, contaminants are forced against the inlet flow tubes 402d, into the larger interior volume 412 of the precleaner 400, and then ultimately ejected through port 114. As the inlet ends of the outlet flow tubes 402e are located within the outlet ends of the inlet flow tubes 402d, the contaminants which are able to be separated and forced against the inner walls of the inlet flow tubes 450 are unable to enter the outlet flow tubes 402e. The tube sheet 402f blocks airflow between the inner cover 406 and the downstream portions of the air cleaner assembly 100 such that all air separated by the air separator tubes 402 must be directed through the outlet flow tubes 402e.

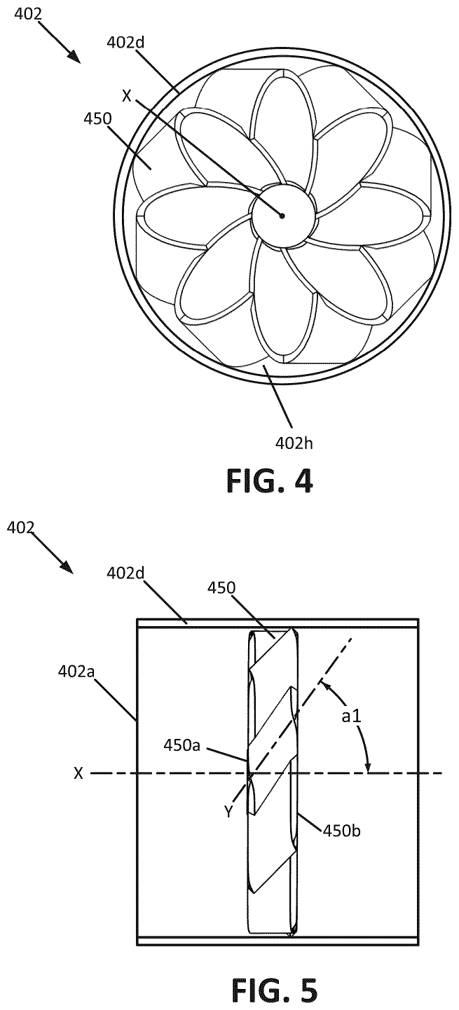

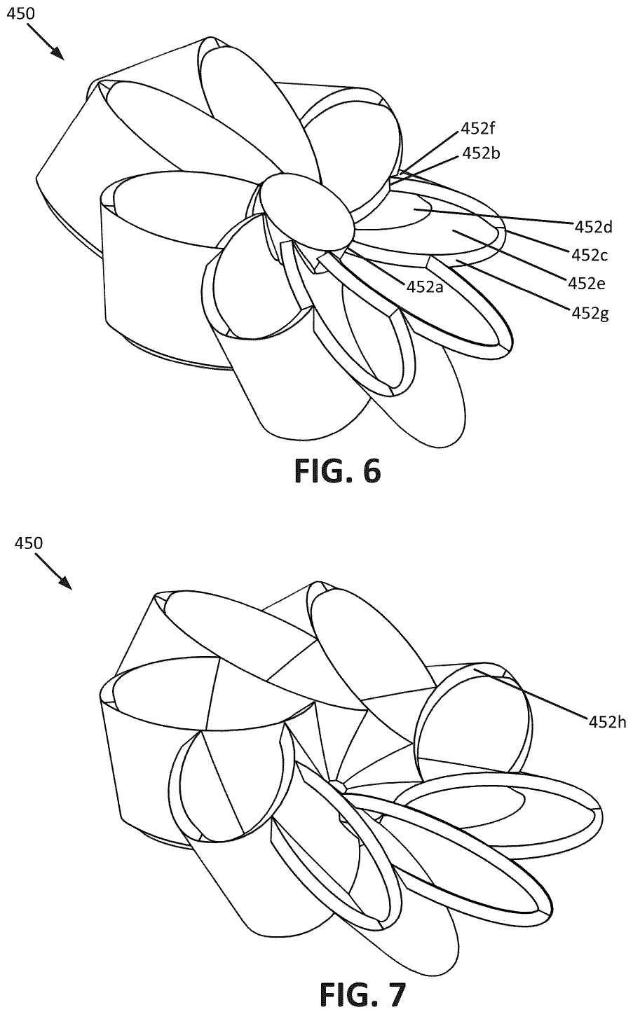

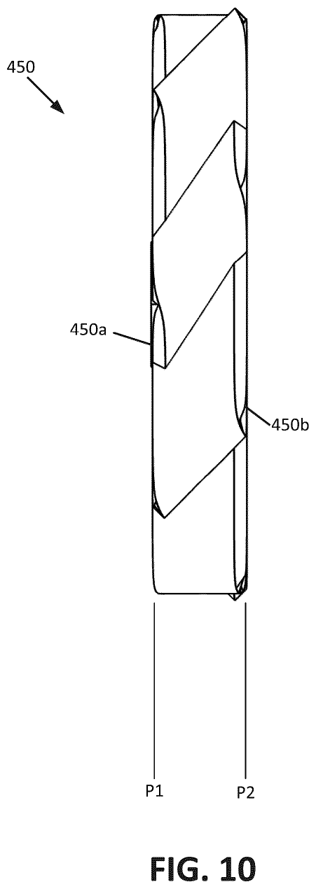

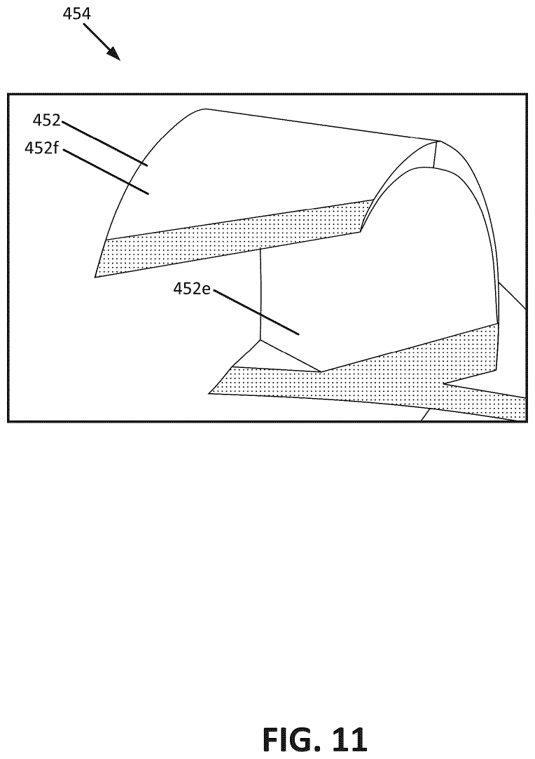

Referring to FIGS. 4-11, the toroidal blade arrangement 450 is shown in greater detail with the toroidal blade arrangement 450 being shown within the inlet flow tube 402d at FIGS. 4 and 5 and being shown in isolation at FIGS. 6-11. In one aspect, the toroidal blade arrangement 450 includes a plurality radially extending blade members 452 arranged about a central portion 454. In the example shown, eight blade members 452 are provided. Other numbers of blade members are possible. As shown, each of the blade members extends from a first end 452a to a second end 452b in a looping or folding fashion such that a radially distal portion 452c is located between to define a radially bounded passageway 452d. By use the term ‘radial bounded passageway’ it is meant to define a passageway that is closed (i.e. not open) at a radially outward edge of the passageway. As can be seen at FIG. 4, the shape of the blade members 452 is such that axial openings 402m between the blade member 452 and the inlet flow tube 402d are created. The axial openings 402h are located at the outer periphery of the opening in the tube 402d and allow air to flow straight through to the opposite side of the blade arrangement 450 without flowing through the passageways 452d. Without being bound to any specific theory, testing appears to show that the provision of openings 402h at the outer periphery of the tube openings appears to aid in generating an advantageous flow profile that results in in enhanced separation and flow performance. In the example shown, the inner side 452e of the radially distal portion 452c of each blade member 452 closes the passageway 452d in a radially outward direction such that air flowing through the passageway 452d is constrained in the radial direction as the air travels from the leading edge 452g toward the trailing edge 452h. In one aspect, the radially distal portion 452c is located at a further distance from a longitudinal axis X of the blade arrangement 450 in comparison to each of the first and second ends 452a, 452b. In one aspect, each blade member 452 is also provided with an inner side surface 452e and an opposite outer side surface 452f that extend between a leading edge 452g and a trailing edge 452h. In the example shown, the blade members 452 are configured and arranged such that both the leading and trailing edges 452g, 452h of each blade member 452 generally define inlet and outlet faces 450a, 450b that extend along parallel planes P1, P2 that are orthogonal to the longitudinal axis X. Other configurations are possible. However, it is noted that the leading and trailing edges 452g, 452h of each blade 450 have edge surfaces that have varying angles between the first and second ends 452a, 454b.

In the example shown, the first end 452a of each blade member 452, at the leading edge 452g, extends from the central portion 454 and, at the trailing edge 452h, extends from the outer side surface 454f of an adjacent blade member 452. In the example shown, the second end 452b of each blade member 452, at both the leading and trailing edges 452g, 452h, extends to an adjacent blade member 452. Other arrangements are possible. For example, the blade arrangement 450 can be formed without a central portion 454 such that the first and second ends 452a, 452b of the blade members 452 fully adjoin an adjacent blade member 452. The blade arrangement 450 could also be formed such that first and second ends 452a, 452b of the blade members 450 extend to the central portion 454.

In one aspect, and as schematically shown at FIG. 5, the passageways 454d extend along an axis Y that is disposed at an oblique angle α1 to the longitudinal axis X of the blade arrangement 450. In the example shown, angle α1 is about 54 degrees. Other angles are possible, for example, angles ranging between 5 and 85 degrees. In the example shown, the entireties of the inner side surfaces 452e of each blade member 452 are parallel to the axis Y. As such, the inner side surfaces 452e may be referred to as defining an extruded surface or shape. As can be seen at FIGS. 4 and 6, this angle in combination with the depth of the blade members 452 defined as the distance between the leading and trailing edges 452g, 452h, prevent a straight through flow or line-of-site flow of air through the passageways 452d in a direction parallel to the longitudinal axis X. Accordingly, as air enters the passageways 452d, the airflow direction is required to change in a direction radially away from the longitudinal axis and towards alignment with the Y axis. As a result, the blade members 454 direct the air into a cyclonic pattern whereby contaminants are forced against the inlet flow tubes 402d, and as described before, into the larger interior volume 412 of the precleaner 400, and then ultimately ejected through port 114.

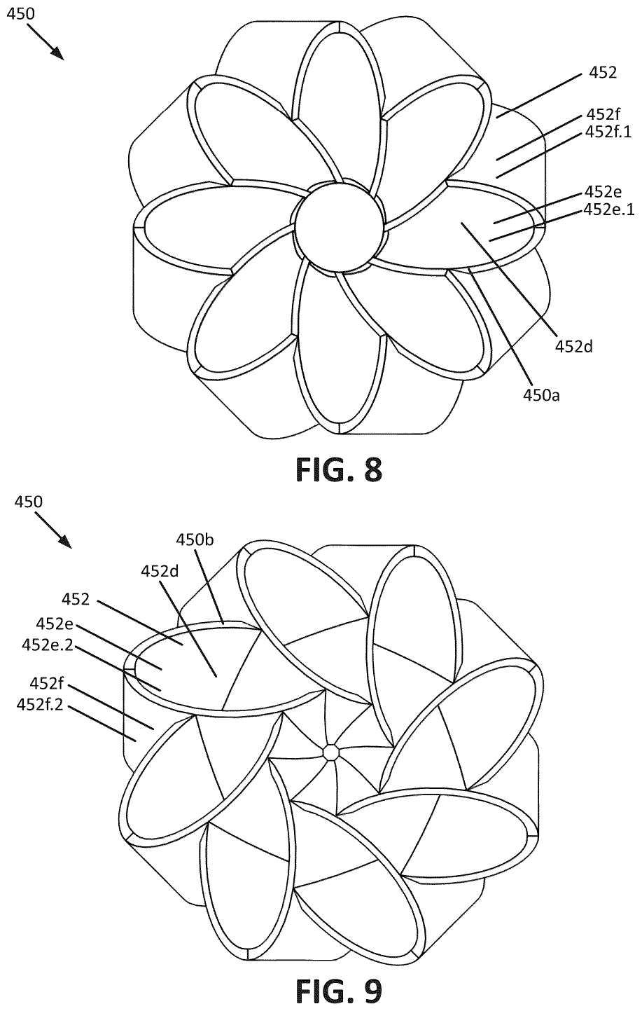

FIGS. 8 and 9 respectively show the blade arrangement 450 from the inlet side 450a and the outlet side 450b. In these views it can be most easily seen that the blade members 452 are looped or folded to form the radially bounded passageways 452d such that a portion 452e.1 of the inner side surface 452e of each blade member 452 faces towards the inlet side 450a while another portion 452e.2 of the inner side surface 452e of the same blade member 452 faces towards the outlet side 450b. Similarly, the blade members 452 are arranged such that a portion 452f.1 of the outer side surface 452f of each blade member 452 faces towards the inlet side 450a while another portion 452f.2 of the outer side surface 452f of the same blade member 452 faces towards the outlet side 450b. Accordingly, the portions 452e.1 and 452f.1 of each blade member 450 may be characterized as defining or forming leading surfaces or faces of the blade members 452 that face generally towards the inlet side 450a. Similarly, the portions 452e.2 and 452f.2 of the same blade member 450 may be characterized as defining or forming trailing surfaces or faces of the blade members 452 that face generally towards the outlet side 450b. Stated another way, a leading face can be defined as one that at least partially faces the inlet side 450a while a trailing face can be defines as one that at least partially faces the outlet side 450b. By use of the terms ‘face generally towards’ and ‘at least partially faces’ with respect to the inlet or outlet sides 450a, 450b, it is meant that the specified surface is at least viewable from a direction orthogonal to the inlet or outlet side 450a, 450b.

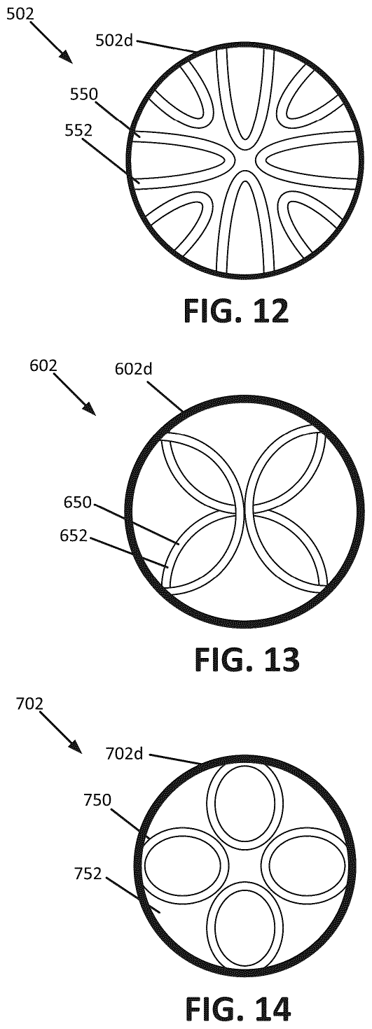

With reference to FIGS. 12-14, additional separator tube arrangements 502, 602, and 702 are presented. As can be seen at FIG. 12, an arrangement with eight non-contacting toroidal blade members 552 is presented in which the blade members 552 are formed with and extend radially inwardly from the inlet flow tube 502d, wherein some of the blade members 552 are differently shaped than some of the other blade members 552. As can be seen at FIG. 13, an arrangement with four toroidal blade member 652 is presented in which adjoining blade members 652 extend from a center of the inlet tube 602d to the inner surface of the inlet tube 602d. As can be seen at FIG. 14, an arrangement with four non-contacting toroidal blade members 752 is presented in which the blade members 752 are formed with and extend radially inwardly from the inlet flow tube 702d.

In some examples, the inlet flow tube and the blade arrangement are formed together as a single component, for example by injection molding or an additive manufacturing process. In some examples, the blade arrangement is separately formed and later attached to the inlet flow tube.

In view of the above, the term ‘toroidal blade arrangement’ may be characterized with one or more of the following definitions: a blade arrangement having at least one blade member that defines a radially bounded passageway; a blade arrangement having at least one blade member extending between first and second ends, wherein the blade member is folded such that the first end extends to a hub member and the second end extends to the hub member or to an adjacent blade member proximate the hub member; a blade arrangement having at least one blade member with opposite first and second side surfaces, wherein the blade member is folded such that the first side surface is always inwardly facing and the second side surface is always outwardly facing; and/or as a blade arrangement having at least one blade member with opposite first and second side surfaces, wherein the blade member is folded such that each of the first and second side surfaces presents a leading and trailing face of the blade member.

### Media Types and Configurations

Any type of filter media can be used as the media pack for the filter cartridges 100, 200 in accordance with embodiments of the invention. For example, woven and non-woven materials using natural and/or synthetic fibers can be used to form fluted filter media, pleated media, and depth media. An exemplary configuration includes fluted filter media, such as a z-filter construction. The term “z-filter construction” as used herein, is meant to refer to a type of filter construction in which individual ones of corrugated, folded or otherwise formed filter flutes are used to define sets of longitudinal, typically parallel, inlet and outlet filter flutes for fluid flow through the media; the fluid flowing along the length of the flutes between opposite inlet and outlet flow ends (or flow faces) of the media. Some examples of filter media are provided in U.S. Pat. Nos. 5,820,646; 5,772,883; 5,902,364; 5,792,247; 5,895,574; 6,210,469; 6,190,432; 6,350,296; 6,179,890; 6,235,195; D399,944; D428,128; D396,098; D398,046; and D437,401, each of which is incorporated herein by reference.

One type of z-filter media utilizes two specific media components joined together to form the media construction. The two components include a fluted (typically corrugated) media sheet and a facing media sheet. The facing media sheet is typically non-corrugated, although it is possible for it to also be corrugated (e.g., perpendicular to the flute direction) as described in U.S. Provisional Application No. 60/543,804, filed Feb. 11, 2004, and published as International Publication WO 2005/077487 on Aug. 25, 2005, which is incorporated herein by reference.

The fluted media sheet and the facing media sheet are used together to define media having parallel inlet and outlet flutes. In some instances, the fluted sheet and facing sheet are secured together and are then coiled as a media strip to form a z-filter media construction. Such arrangements are described, for example, in U.S. Pat. Nos. 6,235,195 and 6,179,890, each of which is incorporated herein by reference.

In certain other arrangements, some non-coiled sections or strips of fluted (typically corrugated) media secured to facing media, are stacked with one another, to create a filter construction.

Corrugated media is a specific form of fluted media, wherein fluted media has individual flutes or ridges (for example formed by corrugating or folding) extending thereacross. The term “corrugated” is used herein to refer to structure in media, such as media having a flute structure resulting from passing the media between two corrugation rollers (e.g., into a nip or bite between two rollers, each of which has surface features appropriate to cause corrugations in the resulting media).

Serviceable filter element or filter cartridge configurations utilizing z-filter media are sometimes referred to as “straight through flow configurations” or by variants thereof. In general, serviceable filter elements or cartridges have an inlet flow end (or face) and an opposite exit flow end (or face), with flow entering and exiting the filter cartridge in generally the same straight through direction. The term “serviceable” in this context is meant to refer to a media containing filter cartridge that is periodically removed and replaced from a corresponding fluid (e.g. air) cleaner.

It is noted that a plurality of embodiments are depicted and described. The embodiments are not meant to be exclusive with respect to features depicted. That is, selected features of one embodiment can be applied in one or more of the other embodiments if desired, to advantage. In many examples, the filter assembly depicted is an air cleaner assembly, for example, used to filter intake air for an internal combustion engine. Additional applications are possible, for example, applications in which the filter assembly is a crankcase ventilation filter assembly, in which the filter cartridge is used to filter crankcase blowby gases which include, typically, both particulate and liquid contaminant therein. Both type of filter assemblies are generally “gas filter assemblies,” since the carrier stage being filtered is gas (air or crankcase ventilation gases). While the techniques described herein will typically be used in application for gas filtration, they can be used in the filtration of other materials, for example, liquids, if desired.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

What is claimed is:

1. A separator arrangement comprising:
a) a tubular member extending along a longitudinal axis between an inlet end and an outlet end;
b) a separation tube extending at least partially into the outlet end of the tubular member such that an annulus is formed between the separation tube and the tubular member; and
c) a toroidal blade arrangement disposed within the tubular member between the inlet end and the separation tube, the toroidal blade arrangement including a plurality of blade members defining an inlet side and an outlet side, each of the plurality of blade members:
i) extending from a first end to a second end and between an inner side surface and an opposite outer side surface; and
ii) being looped such that a first portion of the inner side surface defines a leading face that at least partially faces the inlet side, and such that a second portion of the inner side surface defines a trailing face that at least partially faces the outlet side.

2. The separator arrangement of claim 1, wherein one or both of the first and second ends of each of the plurality of blade members extend to an adjacent one of the plurality of blade members.

3. The separator arrangement of claim 1, wherein each of the plurality of blade members extends between a leading edge and a trailing edge, and wherein one or both of the leading and trailing edges extend along a plane that is generally orthogonal to the longitudinal axis.

4. The separator arrangement of claim 3, wherein the leading edges generally extend along a first plane and the trailing edges generally extend along a second plane that is parallel to the first plane.

5. The separator arrangement of claim 1, wherein the inner side surface of each of the plurality of blade members defines a radially bounded passageway extending along a second axis disposed at an oblique angle to the longitudinal axis.

6. The separator arrangement of claim 5, wherein the inner side surface defines an extruded surface.

7. The separator arrangement of claim 1, wherein the blade arrangement includes a central portion to which at least a portion of each of the plurality of blade members extends.

8. The separator arrangement of claim 1, wherein none of the plurality of blade members contacts another of the plurality of blade members.

9. The separator arrangement of claim 1, wherein at least one of the plurality of blade members has a size or shape that is different from at least one other of the plurality of blade members.

10. A separator arrangement comprising:
a) a tubular member extending along a longitudinal axis; and
b) a toroidal blade arrangement disposed within the tubular member in a fixed position, the toroidal blade arrangement including a plurality of blade members, each of which extends from a first end to a second end with a radially distal portion located between the first and second ends to define a radially bounded passageway extending along a second axis disposed at an oblique angle to the longitudinal axis.

11. The separator arrangement of claim 10, wherein one or both of the first and second ends of each of the plurality of blade members extend to an adjacent one of the plurality of blade members or to a hub portion of the toroidal blade arrangement.

12. The separator arrangement of claim 10, wherein each of the plurality of blade members extends between a leading edge and a trailing edge, and wherein one or both of the leading and trailing edges extend along a plane that is generally orthogonal to the longitudinal axis.

13. The separator arrangement of claim 12, wherein the leading edges generally extend along a first plane and the trailing edges generally extend along a second plane that is parallel to the first plane.

14. The separator arrangement of claim 10, wherein the radially bounded passageway of each of the plurality of blade members is at least partially defined by an inner side surface of the blade member, and wherein the inner side surface is parallel to the second axis.

15. The separator arrangement of claim 14, wherein the inner side surface defines an extruded surface.

16. A pre-cleaner for an air cleaner assembly, the pre-cleaner comprising:
a) a housing extending along a longitudinal axis and between an inlet end for receiving an unseparated airflow stream and an outlet end for delivering a separated airflow stream, the housing including an ejection port for discharging contaminants removed from the unseparated airflow stream; and
b) a separator arrangement disposed within the housing and configured to separate the contaminants from the unseparated airflow stream, the separator arrangement including at least one toroidal blade arrangement mounted in a fixed, non-rotatable position.

17. The pre-cleaner of claim 16, wherein the separator arrangement includes a plurality of toroidal blade arrangements.

18. The pre-cleaner of claim 16, wherein the toroidal blade arrangement includes a plurality of blade members, each of which extends from a first end to a second end with a radially distal portion located between the first and second ends to define a radially bounded passageway extending along a second axis disposed at an oblique angle to the longitudinal axis.

19. The pre-cleaner of claim 16, wherein the separator arrangement includes an inlet flow tube and an outlet flow tube extending at least partially into the inlet flow tube to define an annulus between the inlet and outlet flow tubes, and wherein the toroidal blade arrangement is disposed within the inlet flow tube at a location upstream of the outlet flow tube.

20. An air cleaner assembly comprising:
a) an air cleaner housing;
b) a filter cartridge mounted within the air cleaner housing; and
c) the pre-cleaner of claim 16, wherein the pre-cleaner is mounted to the air cleaner housing at a position upstream of the filter cartridge.
